(19) United States
(12) Patent Application Publication
(10) Pub. No.: US 2021/0386077 A1
(43) Pub. Date: Dec. 16, 2021

(54) TRANSSHIPMENT DEVICE FOR DOUGH PIECES

(71) Applicant: Radie B.V., BC Culemborg (NL)

(72) Inventor: Johannes Josephus Antonius Van Blokland, BG Laren (NL)

(21) Appl. No.: 17/342,129

(22) Filed: Jun. 8, 2021

(30) Foreign Application Priority Data
Jun. 12, 2020 (EP) 20179818.8

(51) Int. Cl. A21C 9/08; A21C 11/12

(52) U.S. Cl. CPC A21C 9/083; A21C 11/12

(57) ABSTRACT

The present invention relates to a transshipment device for dough pieces, comprising at least one carrier picking location, for positioning empty carriers to be picked, at least one carrier loading location, for loading a picked carrier with dough pieces, at least one carrier deposition location, for depositing a carrier loaded with dough pieces, a number of movable grippers for picking, moving and depositing carriers, wherein each gripper is individually movable parallel to a common vertical axis in a vertical direction and each gripper is individually movable in a radial direction from the common vertical axis, multiple grippers project in a different radial direction from the common vertical axis, and all grippers are rotatable together and/or simultaneously about the common vertical axis wherein the at least one carrier picking location, the at least one carrier loading location and the at least one carrier deposition location surround the common vertical axis of rotation, a controller, for controlling movement the grippers, in particular each subsequently along the carrier picking location, the carrier loading location and the carrier deposition location.

### CROSS REFERENCE TO RELATED APPLICATIONS

This application claims priority of European Patent Application No. 20179818.8, filed on Jun. 12, 2020 in the Dutch Patent Office, and herein incorporated by reference in its entirety.

### TECHNICAL FIELD

The present invention relates to a transshipment device for dough pieces, in particular a device for receiving dough pieces and placing them on carriers for further handling, more in particular for being stored in a rack for proofing or being baked.

### BACKGROUND

Devices for that purpose are known in the art. The Austrian patent publication AT508652B1 describes a robot system for manipulating carriers for dough pieces. The system can amongst others be used for displacing carriers from a carrier loading location, and putting them in a rack.

A first disadvantage of this robot system however is that only one tray can be handled at the time. A straightforward disadvantage is that the throughput of such system remains rather low, while the system itself is quite complex.

Evidently, a higher throughput or handling speed of dough products can be obtained by using multiple equal systems in parallel, but such solution would demand an unacceptable footprint in a bakery.

A second disadvantage is that the system according to the prior art forms a bottleneck in a continuous production process, since it handles carriers one by one, and can't continue when for instance a rack is full.

### SUMMARY

It is therefore a goal of the present invention, to provide a system that allows a higher throughput with the least of complexity, and with dimensions that allow a practical implementation.

The invention thereto proposes a transshipment device for dough pieces, comprising at least one carrier picking location, for positioning empty carriers to be picked, at least one carrier loading location, for loading a picked carrier with dough pieces, at least one carrier deposition location, for depositing a carrier loaded with dough pieces, and a number of movable grippers for picking, moving and depositing carriers, wherein each gripper is individually movable parallel to a common vertical axis in a vertical direction and each gripper is individually movable in a radial direction from the common vertical axis, and multiple grippers project in a different radial direction from the common vertical axis, and all grippers are rotatable together and/or simultaneously about the common vertical axis, wherein the at least one carrier picking location, the at least one carrier loading location and the at least one carrier deposition location surround the common vertical axis of rotation, and a controller, for controlling movement the grippers, in particular each subsequently along the carrier picking location, the carrier loading location and the carrier deposition location.

### BRIEF DESCRIPTION OF THE DRAWINGS

The invention will be elucidated into more detail with reference to the following figure, wherein:

FIG. 1 shows a perspective top view of a device according to the present invention; and

FIG. 2 shows a schematic overview of carrier movement at a carrier loading location.

### DETAILED DESCRIPTIONS

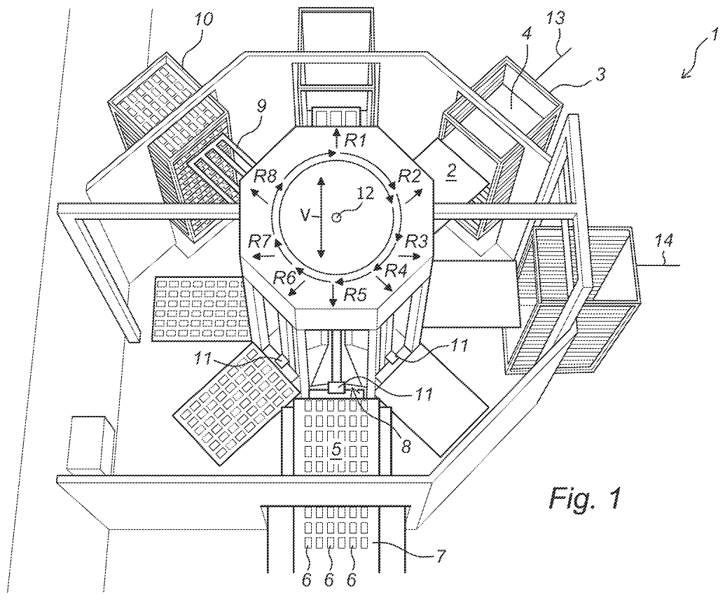

FIG. 1 shows a perspective top view of a device 1 according to the present invention, comprising a carrier picking location 2, for positioning empty carriers 4 to be picked. In this embodiments, the carriers are placed on a movable rack 3, in which they are stacked. The device further comprises a carrier loading location 5, for loading a picked carrier 4 with dough pieces 6. The dough pieces are provided by a conveyor belt 7, provided with a reciprocate-retract system 8 for depositing the dough pieces on a carrier 4 that is placed below the conveyor 7 level. The device further comprises a carrier deposition location 9, comprising a second movable rack 10, for depositing carriers 4 loaded with dough pieces 6. The device has a number of movable grippers 11 for picking, moving and depositing carriers 4, wherein each gripper is individually movable along a common vertical axis 12 in a vertical direction V, and each gripper is individually movable in a radial direction R1, R2, R3, R4, R5, R6, R7, R8 from the common vertical axis 12. The radial directions R1, R2, R3, R4, R5, R6, R7, R8 are all different and in the embodiment shown all at a same angular rotation from each other. All grippers 11 are rotatable together and/or simultaneously about the common vertical axis 12 and the carrier picking location 3, the carrier loading location 7 and the carrier deposition location 9 surround the common vertical axis of rotation 12. During use, the grippers are moved, in particular each subsequently along the carrier picking location 3, the carrier loading location 7 and the carrier deposition location 9.

In the embodiment shown in FIG. 1, the values of the different radial directions R1, R2, R3, R4, R5, R6, R7, R8 in which the grippers 11 project have a common denominator of 45 degrees with respect to a first reference angle 13 defined as zero and the at least one carrier picking location, the at least one carrier loading location 4 and the at least one carrier deposition location 9 are surrounding the common vertical axis of rotation 12 under mutual angles differing with the same common denominator of 45 degrees with respect to a second reference angle 14 defined as zero.

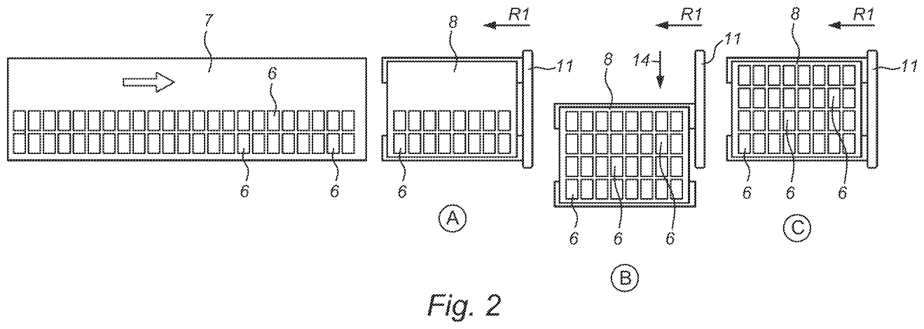

FIG. 2 shows a schematic overview of carrier 8 movement at a carrier loading location 5, which may form part of the device 1 from FIG. 1. The eight (8) grippers 11 are further movable in a horizontal direction 14 perpendicular to its radial direction R1 with respect to the common vertical axis. FIG. 2 shows three steps. In step A, the carrier 8 is aligned with the conveyor 7, on which dough products 6 are arranged. The dough products 6 are placed in two lanes, which are smaller than the available area on the carrier 8. As a result, the carrier 8 is only filled half Therefore, while the reciprocate-retract system retracts, the carrier 8 is moved in a direction 14 perpendicular to the radial direction R1 with respect to the common vertical axis 12. Step B shows the result after a second loading run. After that, the carrier 8 is moved back to its initial orientation, and all carriers may be rotated simultaneously around the common vertical axis 12.

By suspending all grippers 11 on a common axis of rotation, a compact system is obtained. At least one carrier picking location 2, carrier loading location 5 and carrier deposition location 9 surround the common vertical axis 12 of rotation, but multiple ones are thinkable too, and in fact, make the system even more effective, since a single vertical axis can easily be surrounded by multiple locations within the space that would normally be occupied for a single carrier handler according to the state of the art. Even further scaling up is possible, be it with an acceptable concession to the absolute footprint. The vertical axis with the grippers 11 serves as a carousel, which leads all grippers 11 for the carriers along the various locations subsequently. The carousel construction allows a single motor or drive, a minimum of bearings and cabling. Most important however is that the system allows to use multiple carrier depositing locations, which can act as a buffer, which allows to use the system according to the present invention in continuous production lines, and to compensate for irregularities in the rest of the dough line. Additionally, it makes the logistics of providing and removing carriers less time critical, because they can be buffered.

The values of the different radial directions R1-R8 in which the grippers 11 project may preferably have a common denominator larger than 5 degrees and preferably have a common denominator of 15, 30, 45, 60, 90 or 120 degrees with respect to a first reference angle defined as zero. In other words, they are all at the same angular displacement from each other, possibly skipping one or more positions, if it is not necessary to maximize the number of grippers. The same then goes for the at least one carrier picking location 2, the at least one carrier loading location 5 and the at least one carrier deposition location 9: they may preferably surround the common vertical axis 12 of rotation under mutual angles differing with the same common denominator with respect to a second reference angle defined as zero.

In an optimal situation, there are a number N locations, equally distributed around the vertical axis, mutually spaced 360/N degrees, and there is the same number of grippers, at the same mutual spacing of 360/N degrees.

With that choice, one gripper being lined-out with a location means that all grippers are lined out with a location, and by rotating the common vertical axis over 360/N degrees, all grippers arrive at a next location.

Therein, it is possible that at least one carrier picking location 2 and at least one carrier deposition location 9 are the same location. That means that carriers are picked from a location, provided with dough pieces and returned to the same location. Such location may be configured for receiving a rack for stacking carriers, specifically a displaceable rack with wheels. The carrier picking location and carrier deposition location may in general be configured for receiving a rack for stacking carriers, preferably displaceable racks with wheels.

The at least one carrier loading location 5 comprises a conveyor belt 7, in particular provided with a reciprocate-retract system having a movable nose bar, for loading a picked carrier with dough pieces. In such case, a carrier can be placed below the reciprocate-retract system, and receive dough pieces.

It is thinkable that the dough pieces are provided in a number of lanes that is too small to fill the entire carrier in one run. For that purpose, at least one gripper may further be movable in a horizontal direction perpendicular to its radial direction with respect to the common vertical axis. After a first run of the reciprocate-retract system, a second run can be made with a shift of the carrier over the distance of a number of lanes of dough pieces.

Besides a carrier picking location 2, a carrier loading location 5 and a carrier deposition location 9, the device according to the invention may further comprise a dough processing device, located around the common vertical axis of rotation, for performing a processing step, such as a decoration, moistening, scoring or strewing step on the dough products on a carrier, or a cleaning step of the carriers.

The controller may be configured for rotating the common vertical axis 12 and the grippers 11 when a carrier is filled with dough products, and in particular be configured for rotating the common vertical axis 12 over an angle with a common denominator larger than 5 degrees and preferably 15, 30, 45, 60, 90 or 120 degrees, in particular an angle that corresponds to the smallest angle between two adjacent grippers 11.

The controller may further be configured to deposit carriers with dough products at a carrier depositing location in a top-down sequence, starting with a highest position and ending with a lowest position.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A transshipment device for dough pieces, comprising:
at least one carrier picking location, for positioning empty carriers to be picked;
at least one carrier loading location, for loading a picked carrier with dough pieces;
at least one carrier deposition location, for depositing a carrier loaded with dough pieces;
a number of movable grippers for picking, moving and depositing carriers, wherein:
each gripper is individually movable parallel to a common vertical axis in a vertical direction;
each gripper is individually movable in a radial direction from the common vertical axis;
multiple grippers project in a different radial direction from the common vertical axis; and
all grippers are rotatable together and/or simultaneously about the common vertical axis;
wherein:
the at least one carrier picking location, the at least one carrier loading location and the at least one carrier deposition location surround the common vertical axis of rotation; and
a controller, for controlling movement the grippers, in particular each subsequently along the carrier picking location, the carrier loading location and the carrier deposition location.

2. The device according to claim 1, wherein the values of the different radial directions in which the grippers project have a common denominator larger than 5 degrees and preferably 15, 30, 45, 60, 90 or 120 degrees with respect to a first reference angle defined as zero; and
wherein the at least one carrier picking location, the at least one carrier loading location and the at least one carrier deposition location are surrounding the common vertical axis of rotation under mutual angles differing with the same common denominator with respect to a second reference angle defined as zero.

3. The device according to claim 1, wherein at least one carrier picking location unloading and at least one carrier deposition location are the same location.

4. The device according to claim 1, wherein the least one carrier picking location is configured for receiving a rack for stacking carriers.

5. The device according to claim 1, wherein the at least one carrier loading location comprises a conveyor belt, in particular provided with a reciprocate-retract system for loading a picked carrier with dough pieces.

6. The device according to claim 1, wherein the at least one carrier deposition location is configured for receiving a rack for stacking carriers.

7. The device according to claim 1, comprising a dough processing device, located around the common vertical axis of rotation, for performing a processing step, including a decoration, moistening, scoring or strewing step on the dough products on a carrier, or a cleaning step of the carriers.

8. The device according to claim 1, wherein at least one gripper is further movable in a horizontal direction perpendicular to its radial direction with respect to the common vertical axis.

9. The device according to claim 1, wherein the controller is configured for rotating the common vertical axis and the grippers when a carrier is filled with dough products.

10. The device according to claim 9, wherein the controller is configured for rotating the common vertical axis over an angle with a common denominator larger than 5 degrees and preferably 15, 30, 45, 60, 90 or 120 degrees, in particular an angle that corresponds to the smallest angle between two adjacent grippers.

11. The device according to claim 1, wherein the controller is configured to deposit carriers with dough products at a carrier depositing location in a top-down sequence, starting with a highest position and ending with a lowest position.
